(19) United States
(12) Patent Application Publication
(10) Pub. No.: US 2002/0073795 A1
(43) Pub. Date: Jun. 20, 2002

(54) Low noise planetary gear design

(76) Inventors: Joen Christen Bodtker, Flint, MI (US); Brian Jack McNalley, Hemlock, MI (US)

Correspondence Address: EDMUNDO P. ANDERSON, DELPHI TECHNOLOGIES, INC., Legal Staff, P.O. Box 5052, Mail Code: 480-414-420, Troy, MI, 48007-5052, US

(21) Appl. No.: 09/737,909

(22) Filed: Dec. 15, 2000

(51) Int. Cl. F16H 55/17

(52) U.S. Cl. 74/460

(57) ABSTRACT

A planet gear includes a toothed portion having a bore extending axially therethrough, a hub disposed within the bore such that an annular space is defined between the hub and the toothed portion, and an elastomeric element injection-molded into the annular space. The toothed portion includes a first groove circumferentially disposed in an inner surface of the toothed portion, and the hub includes a second groove circumferentially disposed in a peripheral surface of the hub. The grooves provide surfaces upon which the injection-molded elastomer can set. Holes may be disposed axially within the elastomeric element to decrease the spring rate of the elastomer, thereby providing additional radial compliancy to the planet gear. A method for manufacturing the gear includes disposing the hub within the bore of the toothed portion, injecting the elastomer in the annulus defined by the hub disposed within the bore, and curing the injected elastomer. A method for manufacturing the gear having axially disposed holes within the elastomer includes disposing a plurality of pins in the annulus prior to injecting the elastomer, then removing the pins once the elastomer has cured.

### TECHNICAL FIELD

This disclosure relates to planetary gear systems, and, more particularly, to a planet gear having an injection-molded elastomeric damping element that causes vibration generated during the operation of a planetary gear system into which the planet gear is incorporated to be minimized.

### BACKGROUND

Planetary gear systems typically comprise a plurality of drivable or idler gears (e.g., planet gears) engaged by a pinion (e.g., a sun gear). Because they share a single load between several meshes of gears, planetary gear systems are generally more compact than parallel shaft drives and offer significant space savings.

The problem of the audible noise is exacerbated as the result of two conditions that exist within the planetary gear system. The first condition is a function of the material of fabrication of the gears. Typically, at least one of the gears is fabricated from metal. Metal gears provide a much more aggressive impact of the surfaces of the gear teeth when the gears mesh during the operation of the system. Such aggressive impact increases the amount of noise generated. The second condition is a function of the damping aspects of the system. Planet gears of the related art generally include a bushing positioned axially within an outer portion of the gear. Elastomeric O-rings may be disposed between the outer portion of the gear and the bushing to transfer vibration from the teeth of the gear to the hub and the remainder of the system, thereby reducing audible noise. The elastomeric O-rings, however, are typically pre-fabricated and inserted into the gear/bushing assembly mechanically. Because they are mechanically inserted into the assembly, they can oftentimes be easily removed during operation of the gear system if the system experiences continual jarring motion or frequent sudden impacts. Furthermore, the assembly of a gear system in which an elastomeric O-ring is disposed between the outer portion and the bushing affords opportunity for foreign particulate matter or debris to be inadvertently introduced into the gear system. Finally, the assembly of the elastomeric O-ring and the gear components creates an additional manufacturing operation.

### SUMMARY

A low noise planet gear for use in a planetary gear system and a method of manufacturing such a gear are described herein. An injection-molding technique is used to dispose an elastomeric element between the structural components of the planet gear. The elastomer used to form the elastomeric element allows for a compliant relationship to be maintained between the toothed portion of the gear and the hub of the gear and is selected on the basis of the desired properties of the cured elastomer and their effect on the gear during its operation. The elastomer, in conjunction with the architecture of the planet gear, provides for a radial spring rate and a radial damping ability that effectively minimizes the amount of vibration transferred to other elements of the planetary gear system.

The planet gear includes a toothed portion having a bore extending axially therethrough, a hub disposed within the bore such that an annular space is defined between the hub and the toothed portion, and an elastomeric element injection-molded into the annular space. The toothed portion includes a first groove circumferentially disposed in an inner surface of the toothed portion, and the hub includes a second groove circumferentially disposed in a peripheral surface of the hub. In place of the grooves, ridges may be disposed circumferentially on either or both the inner surface of the toothed portion and the peripheral surface of the hub. The grooves or ridges provide surfaces upon which the injection-molded elastomer can set. Holes may be disposed radially in the faces of the planet gear and axially within the elastomeric element to decrease the spring rate thereof, thereby providing additional radial compliancy to the planet gear.

A method for manufacturing the gear includes disposing the hub within the bore of the toothed portion, injecting the elastomer into the annular space defined by the hub disposed within the bore, and curing the injected elastomer. A method for manufacturing the gear having axially disposed holes within the elastomer includes disposing a plurality of pins in the annulus prior to injecting the elastomer, then removing the pins once the elastomer has cured.

### BRIEF DESCRIPTION OF THE DRAWINGS

FIG. 1 is a perspective view of a planetary gear system.

FIG. 2 is a front elevation view of a face of a toothed portion of a planet gear.

FIG. 3 is a side sectional view of the toothed portion of the planet gear of FIG. 2.

FIG. 4 is a front elevation view of a face of a hub of a planet gear.

FIG. 5 is a side sectional view of the hub of the planet gear of FIG. 4.

FIG. 6 is a front elevation view of a planet gear having an elastomeric element disposed therein.

FIG. 7 is a side sectional view of the planet gear of FIG. 6.

FIG. 8 is a front elevation view of a planet gear having an elastomeric element having holes disposed therein.

FIG. 9 is a side sectional view of the planet gear of FIG. 8.

### DETAILED DESCRIPTION

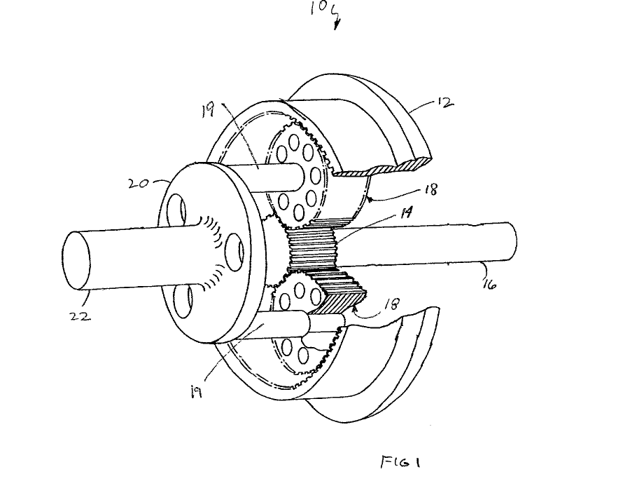

Referring to FIG. 1, a planetary gear system is shown generally at 10. Planetary gear system 10 reduces the speed of an input shaft and multiplies its torque. Applications in which planetary gear system 10 may be incorporated include, but are not limited to, various automotive steering and drive systems, aircraft and marine drive systems, and turbine engine reduction gear systems. In particular, planetary gear system 10 may be part of a rear electric steering mechanism for a motor vehicle.

Planetary gear system 10 comprises a ring gear 12, a sun gear 14 rotatably positioned within ring gear 12 and driven by an input shaft 16, and a plurality of planet gears, two of which are shown generally at 18. Planet gears 18 are configured to be in meshed engagement simultaneously with an outer toothed surface of sun gear 14 and an inner toothed surface of ring gear 12. Each planet gear 18 is axially and rotatably positioned on a dowel pin 19 mounted to a planet carrier 20. In one embodiment, each planet gear 18 rotates perimetrically about sun gear 14 and within ring gear 12 to simultaneously apply a load to planet carrier 20, which rotates to apply a torque to an output shaft 22 depending from planet carrier 20. In another embodiment (not shown), planet gears rotate on a planet carrier, which remains fixed relative to a sun gear, to apply a load to a ring gear. The ring gear then rotates to apply a torque to an output shaft (not shown) depending from the ring gear. Although planet gear 18 is applicable to either embodiment, only the configuration in which the output shaft depends from the planet carrier is described herein.

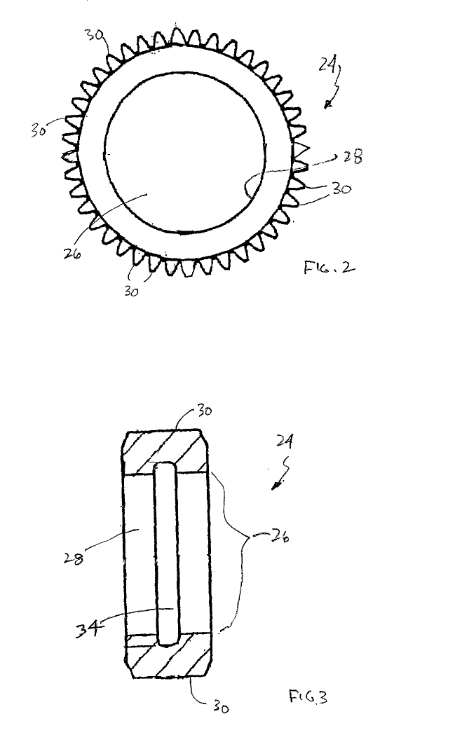

Planet gear 18 comprises a toothed portion, a hub, and an elastomeric element disposed therebetween to provide compliancy during the operation of planetary gear system 10 in which planet gear 18 is incorporated. Referring now to FIGS. 2 and 3, toothed portion, shown generally at 24, is illustrated in detail. Toothed portion 24 comprises a bore 26 defined by an inner surface 28 extending axially through the geometric center of toothed portion 24. Gear teeth 30 extend radially outward from an outer surface of the body of toothed portion 24. Teeth 30 are configured and dimensioned to engage the teeth of both the sun gear and the ring gear and to effectuate the movement of the planet carrier during operation of the planet gear system. A first continuous groove 34 is formed circumferentially within inner surface 28 and extends completely around inner surface 28. Toothed portion 24 is typically fabricated from a plastic material, which may be a polyamide.

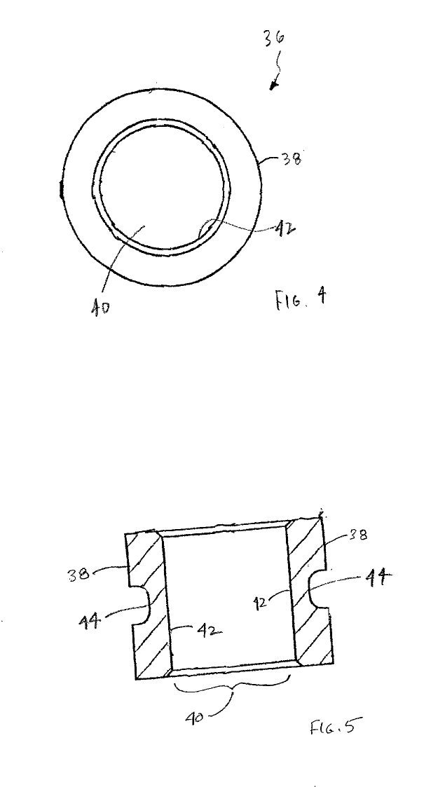

Referring now to FIGS. 4 and 5, hub, shown generally at 36, is illustrated in detail. Hub 36 comprises a cylindrical element having a peripheral surface 38 and a bore 40 defined by an inner surface 42 extending axially therethrough. Bore 40 is typically chamfered at its opposing ends in order to facilitate the rotatable mounting of the planet gear on the dowel pin on the planet carrier. The perimetrical dimensions of hub 36 are less than a diameter of the bore extending through the geometric center of the toothed portion. A second continuous groove 44 formed circumferentially within peripheral surface 38 extends completely around hub 36. Second continuous groove 44 is axially located to correspond with the axial location of the first continuous groove when hub 36 and toothed portion 24 are assembled.

Hub 36 may be fabricated from a polyamide impregnated with a solid lubricant, or it may be fabricated from a metal such as iron. Alternately, steel or some other type of ferrous material may be used. Iron, however, provides damping characteristics that are superior to those of steel. Additionally, the graphite flake structure of iron imparts an inherent lubricity to a hub made from iron, which causes minimal friction to be realized by the rotation of hub 36 on the dowel pin. Furthermore, the use of iron or a ferrous metal provides an impedance mismatch between the toothed portion and hub 36, thereby providing a more effective barrier against the transmission of vibration from the planet gear to planetary gear system 10.

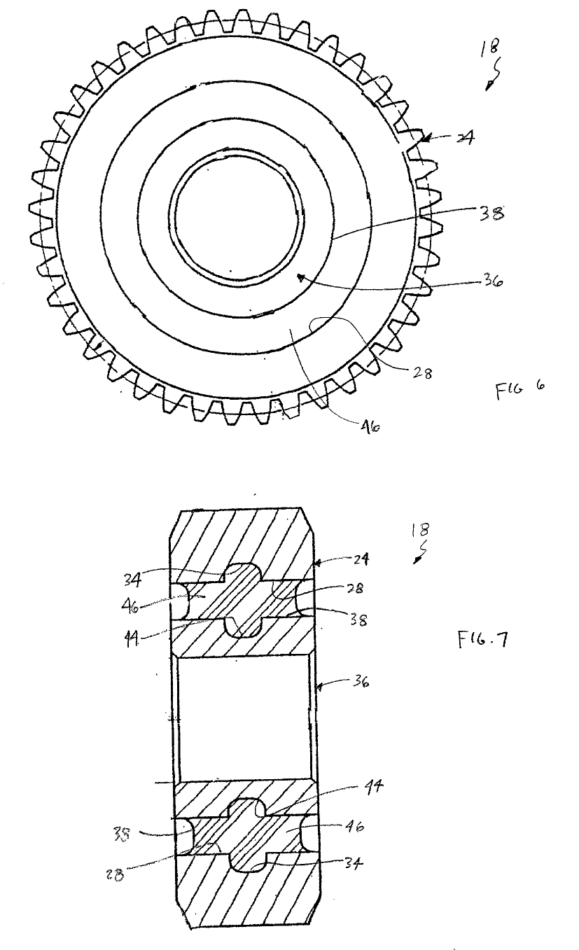

Referring now to FIGS. 6 and 7, the assembled planet gear 18 is illustrated. The coaxial assembly of toothed portion 24 and hub 36 defines an annulus between peripheral surface 38 of hub 36 and inner surface 28 of toothed portion 24 in which an elastomeric element 46 is accommodated. The annulus is defined by first and second grooves 34, 44, as can be seen in FIG. 7, which are each typically of a rectangular cross sectional shape or a similar geometry. Other geometries in which first and second grooves 34, 44 can be configured include, but are not limited to, semi-circular, triangular, or trapezoidal cross sectional shapes.

First and second grooves 34, 44 are dimensioned such that the gap defined therebetween is of a size that provides improved retention of hub 36 within toothed portion 24 when planet gear 18 is properly assembled. In particular, when the elastomer is disposed within the annulus and cured to form elastomeric element 46, hub 36 is secured into place within tooth portion 24 and is prevented from axial movement relative to tooth portion 24 without first tearing elastomeric element 46. By selecting an elastomeric material that has known resiliency, hardness, and tear properties, the amount of force required to cause planet gear 18 to fail can be predetermined for a specific application.

Elastomeric element 46 is disposed in the annulus formed by the coaxial assembly of hub 36 within toothed portion 24 to effectuate a compliant relationship between toothed portion 24 and hub 36. The annulus is defined as having a cross-shaped cross section. Such a shape maximizes the surface area over which elastomeric element 46 engages toothed portion 24 and hub 36, thereby enabling elastomeric element 46 to provide improved axial retention of hub 36 within toothed portion 24. Such a configuration may provide for the torsional retention of hub 36 within toothed portion 24 by providing friction between peripheral surface 38 of hub 36 and elastomeric element 46 and between elastomeric element 46 and inner surface 28 of toothed portion 24. Furthermore, a mild chemical bond may be effectuated between elastomeric element 46 and peripheral surface 38 of hub 36 to either further or alternately provide torsional resistance between elastomeric element 46 and hub 36.

Elastomers used in the formation of elastomeric element 146 include, but are not limited to, thermoset rubbers such as nitrile rubber, natural rubber, polychloroprene rubber, and silicone rubber. The elastomer of choice is determined by the properties of the elastomer, the particular application, and the likelihood that the elastomer will withstand the environmental conditions that the planet gear into which the elastomer is incorporated is subjected to. In addition to thermoset rubbers, various types of thermoplastic materials may be used to form elastomeric element 46. Thermoplastic materials exhibit rubber-like characteristics but can be processed like plastic, which makes them likely candidates for injection-molding processes. One particular thermoplastic material that can be used is SANTOPRENE®, which is available from Advanced Elastomer Systems, located in Akron, Ohio.

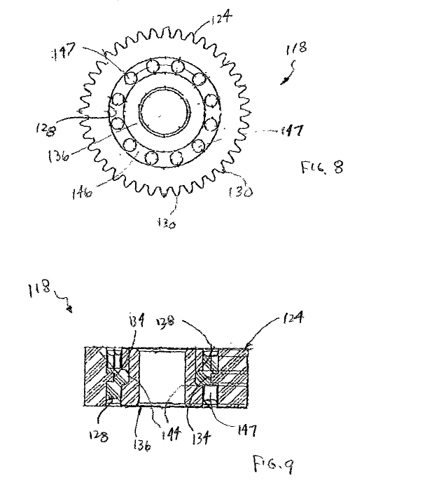

Referring now to FIGS. 8 and 9, another embodiment of a planet gear is shown generally at 118. Planet gear 118 comprises a toothed portion 124, a hub 136 disposed axially within toothed portion 124, and an elastomeric element 146 disposed therebetween. Planet gear 118 is configured similarly to planet gear 18 as shown in FIGS. 6 and 7. Planet gear 118, however, includes holes 147 disposed axially through elastomeric element 146 in order to impart compliance to planet gear 118 in directions radial to an axis extending through hub 136 of planet gear 118.

Toothed portion 124 comprises a bore defined by an inner surface 128 extending axially through the geometric center of toothed portion 124. Gear teeth 130 extend radially outward from an outer surface of the body of toothed portion 124 and are configured and dimensioned to engage the teeth of both the sun gear and the ring gear of a planetary gear system into which planet gear 118 is incorporated, thereby effectuating the movement of either the planet carrier or the ring gear during operation of the planet gear system. Toothed portion 124 also includes a continuous ridge 134 disposed circumferentially about inner surface 128.

Hub 136 is substantially similar to hub 26 as shown in FIGS. 4 through 7 and comprises a cylindrical element having a peripheral surface 138 and a bore defined by an inner surface 142 extending axially therethrough. A continuous groove 144 is formed circumferentially within peripheral surface 138. When toothed portion 124 and hub 136 are coaxially assembled, continuous ridge 134 corresponds to the positioning of continuous groove 144.

Elastomeric element 146, which may be a thermoset rubber or thermoplastic material as described above, is disposed in the annulus formed by the coaxial assembly of hub 136 within toothed portion 124. Elastomeric element 146 is, however, formed to include holes 147 disposed axially therethrough. Holes 147, which may vary in number, cross sectional shape, and positioning within elastomeric element 146, provide planet gear 118 with a decreased radial spring rate and impart enhanced radial damping characteristics to elastomeric element 146.

Holes 147 are formed by the insertion of pins (not shown) into the annulus formed between toothed portion 124 and hub 136 during the coaxial assembly thereof. The pins may be fixedly disposed on a molding die (not shown) that is used to form planet gear 118, thereby causing the simultaneous insertion of the pins into the annulus. The pins are dimensioned to extend into the annulus a predetermined distance and may engage continuous ridge 134. An elastomer is typically injection-molded into the annulus between toothed portion 124 and hub 136 and around the pins. Upon curing of the elastomer, elastomeric element 146 is formed. The pins are removed from elastomeric element 146, either individually or in unison by the retrieval of the molding die, to leave holes 147. Holes 147 can also be mechanically formed in a cured elastomer disposed in the annulus using a drilling, boring, or similar technique.

Regardless of the structural configuration of the radially compliant planet gear, one of the benefits occasioned by the use of an injection-molded elastomer into the annulus formed between the toothed portion and the hub is that of a reduced chance of having foreign particles disposed on the surfaces of the toothed portion and the hub that are engaged by the elastomer during the assembly of the gear. The injection-molding process facilitates the displacement of any contaminating matter disposed on the surfaces of the grooves or ridges disposed in the toothed portions or hubs during the manufacturing of the parts of the planet gear. Furthermore, the injection-molding process eliminates the mechanical disposition of a pre-formed elastomeric element (e.g., an O-ring or a similar element) into the planet gear assembly.

Another of the benefits occasioned by the use of a single elastomeric element injection-molded into the annulus between the hub and the toothed portion is that in the event of a manufacturing oversight that results in the omission of the elastomeric element, the condition is immediately discovered. Because the elastomeric element provides support for the assembly of the hub within the toothed portion, the absence of the elastomeric element causes the planet gear to fall apart. Such a condition is extremely noticeable during manufacturing procedures. By immediately discovering the absence of the elastomeric element, the cause of the defective planet gear can be corrected, thereby preventing the release of an incomplete final product.

While preferred embodiments have been shown and described, various modifications and substitutions may be made thereto without departing from the spirit and scope of the invention. Accordingly, it should be understood that the present invention has been described by way of illustration only, and such illustrations and embodiments as have been disclosed herein are not to be construed as limiting to the claims.

1. A gear, comprising:
a toothed portion having a bore extending axially therethrough;
a hub disposed within said bore, said hub being positioned within said bore to define an annular space between said hub and said toothed portion; and
an elastomer injection-molded into said annular space and cured to provide a compliant relationship between said toothed portion and said hub.

2. The gear of claim 1 wherein said toothed portion includes a first groove circumferentially disposed in an inner surface thereof and wherein said hub includes a second groove circumferentially disposed in a peripheral surface thereof, said first groove and said second groove providing surfaces upon which said injection-molded elastomer can set.

3. The gear of claim 1 wherein said elastomer comprises a thermoset material.

4. The gear of claim 3 wherein said thermoset material is selected from the group consisting of nitrile rubber, hydrogenated nitrile rubber, chloroprene rubber, and silicone rubber.

5. The gear of claim 1 wherein said elastomer comprises a thermoplastic material

6. A radially compliant gear, comprising:
a toothed portion having a bore extending axially therethrough;
a hub disposed within said bore, said hub being positioned within said bore to define an annular space between said hub and said toothed portion; and
an elastomeric structure disposed between said toothed portion and said hub, said elastomeric structure having holes extending therein to reduce a spring rate of said elastomeric structure.

7. The radially compliant gear of claim 6 wherein said toothed portion includes a continuous ridge circumferentially disposed on an inner surface thereof.

8. The radially compliant gear of claim 7 wherein said hub includes a continuous groove circumferentially disposed on a peripheral surface of said hub, said continuous groove being positioned in an axial location on said peripheral surface that substantially corresponds with an axial location of said continuous ridge.

9. The radially compliant gear of claim 6 wherein said elastomeric structure is disposed between said toothed portion and said hub by an injection-molding technique.

10. The radially compliant gear of claim 6 wherein said holes are formed by the injection-molding of an elastomer around removable pins disposed within said annular space.

11. The radially compliant gear of claim 6 wherein said holes are formed in an elastomer subsequent to said elastomer being disposed and cured within said annular space.

12. The radially compliant gear of claim 6 wherein said elastomeric structure comprises a thermoset material.

13. The radially compliant gear of claim 12 wherein said thermoset material is selected from the group consisting of nitrile rubber, hydrogenated nitrile rubber, chloroprene rubber, and silicone rubber.

14. The radially compliant gear of claim 6 wherein said elastomeric structure comprises a thermoplastic material.

15. A method for manufacturing a gear, comprising:
disposing a hub within a bore of a toothed portion;
injection-molding an elastomer in an annulus defined by said hub disposed within said bore of said toothed portion; and
curing said injected elastomer.

16. A method for manufacturing a radially compliant gear, comprising:
disposing a hub within a bore of a toothed portion;
disposing a plurality of pins in an annulus defined by said hub disposed within said bore of said toothed portion;
injection-molding an elastomer in said annulus;
curing said elastomer; and
removing said pins to form a plurality of corresponding holes in said cured elastomer.
